(19) United States
(12) Patent Application Publication
(10) Pub. No.: US 2006/0102032 A1
(43) Pub. Date: May 18, 2006

(54) Heating system for printing apparatus

(76) Inventors: Peow Ng, Singapore (SG); Yee Keat Leong, Singapore (SG); Choon Siang Peck, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/977,999

(22) Filed: Oct. 29, 2004

(51) Int. Cl. B41F 35/00

(52) U.S. Cl. 101/424.1

(57) ABSTRACT

A printing apparatus with capability for drying printed media is disclosed. The printing apparatus includes a print zone and a post-printing zone, an advancing mechanism for transporting the print medium through the print zone, a print head for ejecting ink onto the medium as the medium is being transported through the print zone, and a heating system for drying the ink ejected onto the medium. The heating system includes a plurality of thermoelectric modules positioned in the print zone or the post-printing zone. Each thermoelectric module has a heat-rejecting surface and a cooling surface. The heat-rejecting surface of each thermoelectric module is positioned to face the medium being transported.

### BACKGROUND

The present invention relates generally to printing apparatuses, and more particularly, to a heating system for a printing apparatus.

Many printing apparatuses such as computer printers, graphic plotters, copiers, and facsimile machines employ inkjet printing technology. Inkjet printing typically produces images by ejecting tiny ink droplets onto the print media, such as paper. Many of the inks used in inkjet printing are solvent-based, e.g. water-based. However, there are some major problems associated with solvent-based inks. The ink-saturated media may become distorted or wavy, thereby causing a phenomenon called paper “cockle.” Furthermore, if the ink is not properly dried before the printed medium comes into contact with the starwheels positioned on the exit side of the print zone, the wet ink will transfer onto the starwheels then redeposit again onto the printed medium causing tracking. Thus, the solvent must be vaporized or absorbed into the media within a reasonable amount of time after printing.

To facilitate the drying of solvent-based inks in high-speed inkjet printers, several drying techniques have been employed. One technique is convection heating, wherein a heated gas is blown onto the printed medium. Another technique is radiant heating by applying infrared energy to the printed media. A third common heating technique is conductive heating by advancing the printed media around a heated roller or over a heated platen. The conventional heating set-ups often require additional components that add bulkiness to the printers and the corresponding control systems for achieving uniform heating are complicated and costly to install. Furthermore, many conventional heating systems, particularly convection heating systems, are thermally inefficient because they require a large amount of energy consumption. Some heating systems, such as radiant heaters, poses fire hazard and safety problems.

Accordingly, there exists a need for a printing apparatus having a compact and efficient heating system that is relatively inexpensive to install.

### SUMMARY

A printing apparatus with capability for drying printed media is disclosed. The printing apparatus includes a print zone and a post-printing zone, an advancing mechanism for transporting a medium sequentially through the print zone and the post-printing zone along a media transport path, a print head for ejecting ink onto the medium at the print zone during printing operation, and a heating system for drying the printed medium. The heating system includes a plurality of thermoelectric modules positioned in the post-printing zone. Alternatively, the thermoelectric modules may be positioned in the print zone. Each thermoelectric module has a heat-rejecting surface and a cooling surface. The heat-rejecting surface of each thermoelectric module is positioned to face the printed medium to be dried.

The advantages and features of the present invention will become apparent from the detailed description when read in conjunction with the drawings.

### BRIEF DESCRIPTION OF THE DRAWINGS

FIG. 1 shows a sectional view of an inkjet printer with a conductive heating system in accordance with an embodiment of the present invention.

FIG. 2 shows an isometric view of the printer shown in FIG. 1 in accordance with an embodiment of the present invention.

FIG. 3 shows the cross-sectional view of a thermoelectric module that is used in the heating system in accordance with an embodiment of the present invention.

FIG. 4 shows an exploded view of a thermoelectric module installed according to the embodiment of FIG. 1.

FIG. 5 shows a sectional view of an inkjet printer with a convective heating system accordance with another embodiment of the present invention.

FIG. 6 shows an exploded view of the thermoelectric module installed according to the embodiment of FIG. 5.

FIG. 7 is a flow chart illustrating the method for drying a printed medium in accordance with an embodiment of the present invention.

FIG. 8 is a flow chart illustrating the method for drying a printed medium in accordance with an alternative embodiment of the present invention.

### DETAILED DESCRIPTION

The present invention provides a printing apparatus with a heat generator for drying a printed medium. In the following description of the exemplary embodiments, the printing apparatus is an inkjet printer. However, it should be understood that the heat generator may be incorporated in any other printing apparatus employing solvent-based ink.

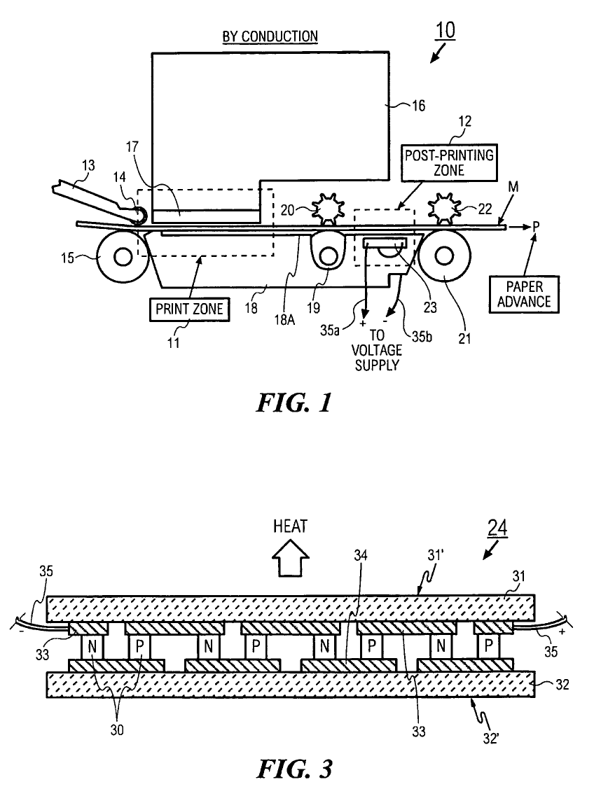

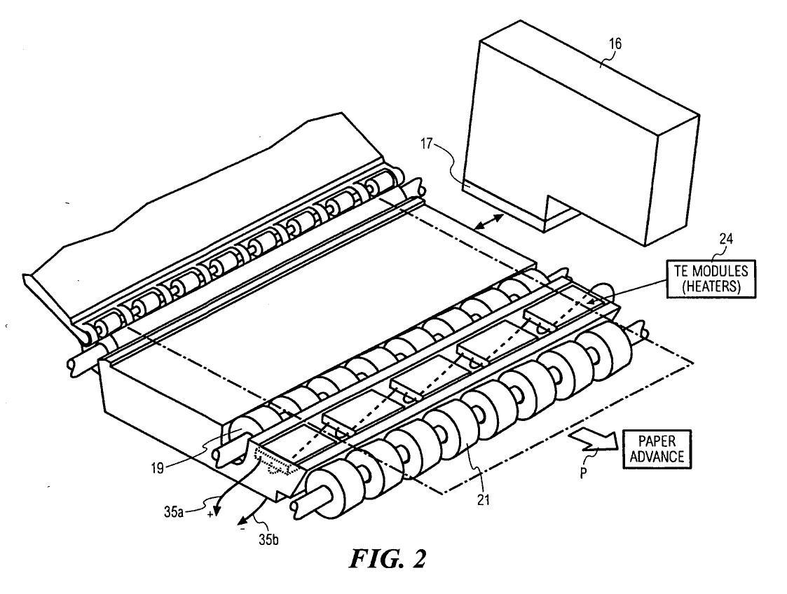

FIGS. 1 and 2 show the cross-sectional view and isometric view, respectively, of an inkjet printer having a conductive heating system in accordance with an embodiment. Referring to FIG. 1, an inkjet printer 10 is provided with a print zone 11 and a post-printing zone 12. A print medium M, e.g. paper, is transported along a media transport path P from an upstream location to the print zone 11 with the aid of an advancing mechanism that includes a paper guide 13, an upper pinch roller assembly 14 and a lower feed roller assembly 15. The print zone 11 is the space in the printer where ink is ejected from a print head 16 onto the print medium. The print head 16 is attached to the underside of an ink cartridge 17, which is mounted on a carriage (not shown).

A printer may have several cartridges, but for convenience, only one is shown. A platen 18 is positioned below the ink cartridge 17 for supporting the print medium M during the passage of the medium through the print zone 11 and the post-printing zone 12. The platen 18 has an upper surface 18a that faces the ink cartridge 17. Primary output roller assembly 19 works in conjunction with a first starwheel 20 to advance the printed medium from the print zone to a post-printing zone 20. Secondary output roller assembly 21 works in conjunction with a second starwheel 22 to advance the printed medium from the post-printing zone 12 to a collection tray or another treatment zone. In order to prevent the ejected ink in the liquid phase from spreading on the medium and to prevent the printed medium from being distorted, a heating system 23 is arranged in the post-printing zone to facilitate ink drying immediately after printing. The heating system 23 is mounted on the post-printing region of the platen's upper surface 18a, which is between the primary and secondary output roller assemblies 19, 21.

Referring to FIG. 2, the heating system includes a plurality of connecting thermoelectric modules 24, which are arranged across the width of the platen. The thermoelectric modules 24 are connected electrically in series so that positive (+) terminal 35a and negative (−) terminal 35b from the outermost modules are free for connection to a voltage supply. Alternatively, the thermoelectric modules 24 could be electrically connected in parallel.

Referring to FIG. 3, each thermoelectric module 24 includes an array of small semiconductor pellets 30 (N and P types) sandwiched between two ceramic plates 31 and 32. The semiconductor pellets 30 are attached to the ceramic plate 31 via conductive bonding pads 33 and to ceramic plate 32 via conductive site pads 34. Positive (+) and negative (−) leads 35 are connected to the outermost conductive bonding pads 33. When a voltage, i.e., DC supply, is applied to the leads 35, heat is absorbed at the ceramic plate 32 and moved to the ceramic plate 31, thereby creating a cooling effect at the ceramic plate 32 and generating heat at the ceramic plate 31. Thus, each thermoelectric module 24 has a heat-rejecting surface 31′ and a cooling surface 32.′ The thermoelectric modules 24 are arranged on the platen 18 so that the heat-rejecting surface 31′ of each module faces up toward the printed medium to be dried. By this arrangement, the thermoelectric modules 24 supply heat to the printed medium by conduction.

The thermoelectric modules 24 are small, very light and relatively silent solid state devices that function as heat pumps. As an example, each thermoelectric module 24 may be 4 mm thick, 6 mm in width and 6 mm in length. The size of the thermoelectric modules may be adjusted in accordance with the heating temperature needed for drying and the space available in the printer.

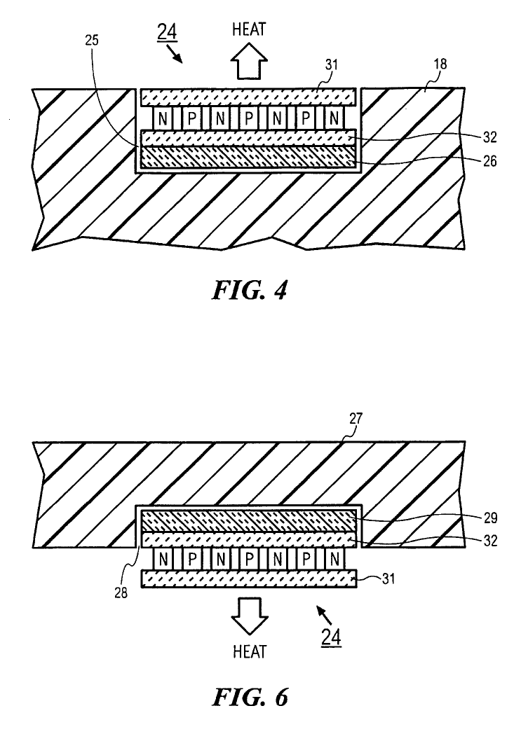

FIG. 4 is an exploded view showing how the thermoelectric modules 24 are installed on the platen 18. The thermoelectric modules 24 are placed in a cavity 25 formed in the platen 18 so that the each ceramic plate 31, where heat is rejected, faces up toward the printed medium to be heated. A thin layer of thermal insulation 26 is placed between the ceramic plates 32 and the platen 18 in order to minimize heat absorption by the cooling surfaces of ceramic plates 32.

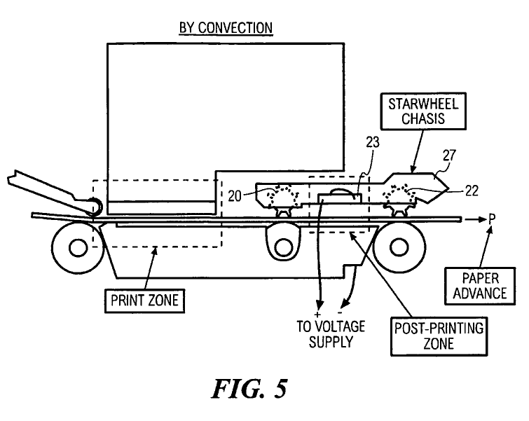

FIG. 5 shows an alternative arrangement for the heating system 23. In this arrangement, the starwheels 20 and 22 are mounted on a starwheel chasis 27, and the heat generator 23 is positioned in the starwheel chasis 27 so that the heat generated is supplied to the printed media by convection.

FIG. 6 is an exploded view showing how the thermoelectric modules 24 are installed on the starwheel chasis 27. The thermoelectric modules 24 are placed in a cavity 28 formed in the starwheel chasis 27 between the starwheels 20 and 22 so that the ceramic plate 31 of each thermoelectric module faces down toward the platen 18. A thin layer of thermal insulation 29 is placed between the ceramic plates 32 and the starwheel chasis 27 in order to minimize heat absorption by the cooling surfaces of the ceramic plates 32.

In the above embodiments, the heating system 23 is installed in the post-printing zone 12. However, it is also useful to have heat applied in the print zone 11 of the printer. Heating in the print zone will reduce ink migration that occurs during printing and in the first few fractions of a second after printing. The thermoelectric modules 24 described above may be installed in the section of the platen 18 that is in the print zone 12, in the same manner described for the embodiment of FIG. 1. When heating the media in the print zone, it is important to ensure that the applied heat is not directed to the print head of the cartridge. If the print head overheats, droplet trajectory can change, thereby reducing print quality. The heating system 23 can fulfill this objective.

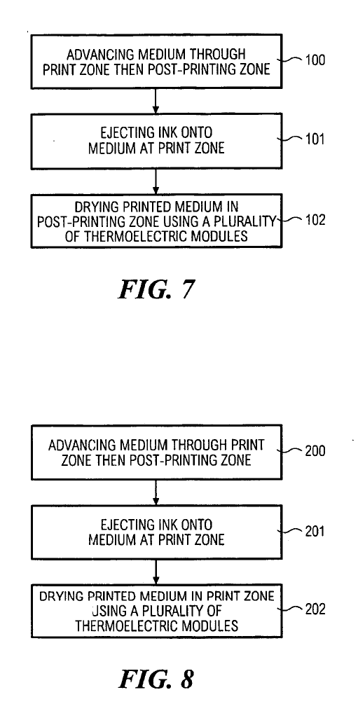

FIG. 7 is a flow chart illustrating the method for drying a printed medium in accordance with an embodiment of the present invention. A medium is advanced sequentially through a print zone then a post-printing zone at step 100. At step 101, ink is ejected onto the medium during printing operation in the print zone. The printed medium is then dried in the post-printing zone at step 102. Drying is affected by arranging a plurality of thermoelectric modules in the post-printing zone as described above.

FIG. 8 is a flow chart illustrating an alternative method for drying a printed medium. In this method, a medium is advanced sequentially through a print zone then a post-printing zone at step 200. Ink is ejected onto the medium during printing operation in the print zone at step 201. The printed medium is dried in the print zone at step 202. Drying is affected by arranging a plurality of thermoelectric modules in the print zone.

The heat generator of the present invention is compact and can be installed at a relatively low cost. Furthermore, the heat generator of the present invention could apply heat to the printed media in a cost-efficient manner.

It is intended that the embodiments contained in the above description and shown in the accompanying drawings are illustrative and not limiting. It will be clear to those skilled in the art that modifications may be made to these embodiments without departing from the scope of the invention as defined by the appended claims.

What is claimed is:

1. A printing apparatus having capability for drying a printed medium comprising:
a print zone and a post-printing zone;
an advancing mechanism for transporting a medium sequentially through the print zone and the post-printing zone along a media transport path;
a print head for ejecting ink onto the medium at the print zone during printing operation; and
a heating system for drying the printed medium,
wherein the heating system comprises a plurality of thermoelectric modules positioned in the post-printing zone, each thermoelectric module having a heat-rejecting surface and a cooling surface, the heat-rejecting surface being oriented to face the printed medium to be dried.

2. The printing apparatus according to claim 1, wherein the thermoelectric modules are electrically connected and aligned in a row so as to extend in a direction substantially orthogonal to the media transport path.

3. The printing apparatus according to claim 1, further comprising a platen having a support surface for supporting the medium during printing operation, the support surface having a first area that is located in the print zone and a second area that is located in the post-printing zone,
wherein the thermoelectric modules are mounted in the second area.

4. The printing apparatus according to claim 1, further comprising a platen having a support surface for supporting the medium during printing operation, the support surface having a first area that is located in the print zone and a second area that is located in the post-printing zone,
wherein the thermoelectric modules are mounted in the first area.

5. The printing apparatus according to claim 3, wherein the platen has a width that extends substantially orthogonal to the media transport path and the thermoelectric modules are aligned in a row so as to extend across the width of the platen.

6. The printing apparatus according to claim 4, wherein the platen has a width that extends substantially orthogonal to the media transport path, and the thermoelectric modules are aligned in a row so as to extend across the width of the platen.

7. The printing apparatus according to claim 1, wherein the post-printing zone comprises two starwheels cooperating with two output roller assemblies for advancing the printed medium from the print zone through the post-printing zone.

8. The printing apparatus according to claim 7, wherein the starwheels are mounted on a starwheel chasis that is positioned above the media transport path, and the thermoelectric modules are mounted on the starwheel chasis so that the heat-rejecting surface of each thermoelectric module faces down toward the printed medium to be dried.

9. A printing apparatus having capability for drying a printed medium comprising:
a print zone and a post-printing zone;
an advancing mechanism for transporting a medium sequentially through the print zone and the post-printing zone along a media transport path;
a print head for ejecting ink onto the medium at the print zone during printing operation; and
a heating system for drying the printed medium,
wherein the heating system comprises a plurality of thermoelectric modules positioned in the print zone, each thermoelectric module having a heat-rejecting surface and a cooling surface, the heat-rejecting surface being oriented to face the printed medium to be dried.

10. A printing apparatus having capability for drying a printed medium comprising:
a print zone and a post-printing zone;
means for transporting a medium sequentially through the print zone and the post-printing zone along a media transport path;
means for ejecting ink onto the medium at the print zone during printing operation; and
means for drying the printed medium in the post-printing zone,
wherein the drying means comprises means for generating a heat-absorbing surface and a heat-rejecting surface, the heat-rejecting surface being oriented to face the printed medium to be dried.

11. A printing apparatus having capability for drying a printed medium comprising:
a print zone and a post-printing zone;
means for transporting a medium sequentially through the print zone and the post-printing zone along a media transport path;
means for ejecting ink onto the medium at the print zone during printing operation; and
means for drying the printed medium in the print zone,
wherein the drying means comprises means for generating a heat-absorbing surface and a heat-rejecting surface, the heat-rejecting surface being oriented to face the printed medium to be dried.

12. A method for drying printed media comprising:
advancing a medium through a print zone then a post-printing zone;
ejecting ink onto the medium at the print zone during printing operation;
drying the printed medium by arranging a heating system in the post-printing zone,
wherein the heating system comprises a plurality of thermoelectric modules, each module having a heat-rejecting surface and a cooling surface, the heat-rejecting surface being oriented to face the printed medium to be dried.

13. The method of claim 12, wherein the ink is a solvent-based ink.

14. A method for drying printed media comprising:
advancing a medium through a print zone then a post-printing zone;
ejecting ink onto the medium at the print zone during printing operation;
drying the printed medium by arranging a heating system in the print zone,
wherein the heating system comprises a plurality of thermoelectric modules, each module having a heat-rejecting surface and a cooling surface, the heat-rejecting surface being oriented to face the printed medium to be dried.
